(19) United States
(12) Patent Application Publication
(10) Pub. No.: US 2014/0183078 A1
(43) Pub. Date: Jul. 3, 2014

(54) REMOVABLE LABEL AND METHOD

(71) Applicants: Tim Newton, Lamoni, IA (US); Connie Newton, Lamoni, IA (US)

(72) Inventors: Tim Newton, Lamoni, IA (US); Connie Newton, Lamoni, IA (US)

(21) Appl. No.: 13/731,322

(22) Filed: Dec. 31, 2012

(51) Int. Cl. B65D 25/20; B32B 43/00

(52) U.S. Cl. CPC B65D 25/205; B32B 43/006
USPC 206/459.5; 156/60

(57) ABSTRACT

A method that includes providing a plastic container with an exterior surface and a polyester substrate with a first face and a second face. A coating of repositionable pressure sensitive adhesive is provided to substantially all of the second face of the polyester substrate. The polyester substrate is adhered to the plastic container by contacting the second face of the polyester substrate and the coating of repositionable pressure sensitive adhesive with the exterior surface of the plastic container. The polyester substrate and all of the coating of repositionable pressure sensitive adhesive may be removed from the plastic container prior to recycling the plastic container by peeling the polyester substrate away from the exterior surface of the plastic container.

### BACKGROUND

The present invention relates to a recyclable container with a label that can be easily removed without leaving any adhesive residue on the recyclable container once the label has been removed.

To achieve the highest quality and value in recycled plastic, the recycling process for plastic must produce recycled plastic largely free of contaminants at little cost. Labels on plastic containers, such as bottles, are a common source of contaminants in the recycling process as the adhesive gluing the labels to the bottles and the ink in the labels can both lower the quality of the recycled plastic if not first removed. Because a large amount of adhesive is generally used on the labels, removing the labels from the bottles is an onerous task. Many prior art methods used by commercial recyclers to remove labels from plastic containers require large capital investment, complicated machinery, and large quantities of water and energy. One method removes labels from bottles through the use of a high rpm drum and the labels are then separated from the production stream through a rotating perforated screen. Such perforated screens get plugged, even after short use, requiring either frequent cleaning or additional steps, such as hand sorting.

Other methods use water soaking, steam, or high pressure water jets to remove the labels. This method is undesirable as the commercial recycler must treat the waste water used in the label removal process. Using water to remove the labels also increases overhead cost, especially for recyclers located in arid climates where water is a scarce and expensive resource. Even after the labels have been removed, it is common for commercial recyclers to subject the bottles to additional removal steps to remove adhesive remnants on the surface of the bottles. Such additional steps generally increase production cost and time. Some commercial recyclers require consumers to remove the labels and adhesive themselves before delivering the bottles to the commercial recycler. Where the burden of removing the labels and adhesive is placed on consumers, many consumers choose to forgo recycling rather than undergo the difficult challenge of removing adhered labels from bottles and other plastic containers.

### SUMMARY

According to the present invention, a combined labeling and recycling method includes providing a plastic container with an exterior surface and a polyester substrate with a first face and a second face. A coating of repositionable pressure sensitive adhesive is provided to substantially all of the second face of the polyester substrate. The polyester substrate is adhered to the plastic container by contacting the second face of the polyester substrate and the coating of repositionable pressure sensitive adhesive with the exterior surface of the plastic container. The polyester substrate and all of the coating of repositionable pressure sensitive adhesive may be removed from the plastic container prior to recycling the plastic container by peeling the polyester substrate away from the exterior surface of the plastic container.

### BRIEF DESCRIPTION OF THE DRAWINGS

FIG. 1 is a perspective view of an embodiment of a plastic container and a label.

FIG. 2 is a perspective view of the embodiment of the plastic container and label from FIG. 1 rotated 180 degrees.

FIG. 3 is a cross sectional top view of the embodiment of the plastic container and label from FIGS. 1 and 2 taken along line A-A.

FIG. 4 is an expanded cross sectional view of the embodiment of the plastic container and label from FIG. 3 taken inside circle B.

FIG. 5 shows a perspective view of the label and plastic container of FIGS. 1-4 with the label partially removed from the plastic container.

FIG. 6 shows a perspective view of the label and plastic container of FIGS. 1-4 with the label partially removed from the plastic container.

FIG. 7 shows a perspective view of the label and plastic container of FIGS. 1-4 with the label completely removed from the plastic container.

FIG. 8 is a front view of another embodiment of a plastic container and a label.

FIG. 9 is a front view of the plastic container and label from FIG. 8 with the label partially removed from the plastic container.

FIG. 10 is a cross sectional top view of the embodiment of the plastic container and label from FIGS. 8 and 9 taken along line C-C.

FIG. 11 is an expanded cross sectional view of the embodiment of the plastic container and label from FIG. 10 taken inside circle D.

FIG. 12 is a back view of another embodiment of a label with a polyester substrate, a second face, and a repositionable pressure sensitive adhesive coating with a pattern.

FIG. 13 is a back view of another embodiment of a label with a polyester substrate, a second face, and a repositionable pressure sensitive adhesive coating with a pattern.

FIG. 14 is a back view of another embodiment of a label with a polyester substrate, a second face, and a repositionable pressure sensitive adhesive coating with a pattern.

FIG. 15 discloses a diagram of a combined labeling and recycling method employing a plastic container and a label.

### DETAILED DESCRIPTION

To achieve the highest quality and value in recycled plastic, the recycling process for plastic must produce recycled plastic largely free of contaminants at little cost. Prior art labels are difficult and costly to remove from plastic containers, such as bottles. Even once prior art labels have been removed from bottles, stubborn adhesive residue from the labels remains on the outside surfaces of the bottles. Additional steps and cost must be taken to remove the adhesive residue or it will contaminate the recycled plastic and degrade its quality and functionality.

In general, the present invention relates to the combined method of labeling and recycling plastic. A plastic container with an exterior surface is provided. A polyester substrate with a first face and a second face is provided as a label. In addition to the polyester substrate, the label also has a coating of repositionable pressure sensitive adhesive provided to substantially all of the second face of the polyester substrate. Repositionable is defined in the context of adhesives as being able to hold a position, being capable of being removed from that position without leaving remnants or residue, and being put into another position and holding that position until subsequent intentional removal. The label is adhered to the plastic container by contacting the second face of the polyester substrate and the coating of repositionable pressure sensitive adhesive with the exterior surface of the plastic container. Prior to recycling the plastic container, the label, along with all of the coating of repositionable pressure sensitive adhesive, is removed by peeling the polyester substrate away from the exterior surface of the plastic container. Because the entire coating of repositionable pressure sensitive adhesive is removed with the polyester substrate of the label, no adhesive residue remains on the exterior surface of the plastic container. The plastic container may then proceed in the recycling process without the additional steps and costs required by bottles bearing prior art labels.

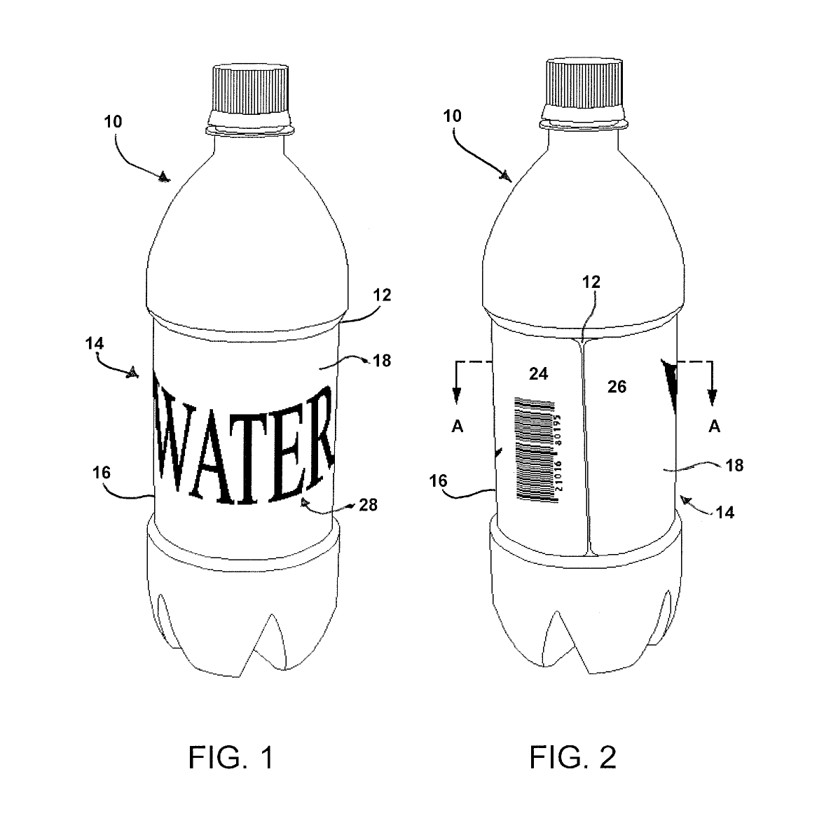

FIG. 1 is a perspective view of an embodiment of plastic container 10 and FIG. 2 is the perspective view of the embodiment of plastic container 10 from FIG. 1 rotated 180 degrees. Plastic container 10 may be any plastic article capable of being recycled. In FIG. 1, plastic container 10 is a beverage bottle. Plastic container 10 includes exterior surface 12, and label 14. Label 14 includes polyester substrate 16, first face 18, second face 20 (shown in FIG. 4), repositionable pressure sensitive adhesive coating 22 (shown in FIG. 4), first edge 24, second edge 26, and length L₁ between first edge 24 and second edge 26. Label 14 may also include indicia 28.

First face 18 of polyester substrate 16 is disposed opposite second face 20 (shown in FIG. 4) of polyester substrate 16. First edge 24 of polyester substrate 16 is disposed opposite second edge 26, and length L₁ of polyester substrate 16 extends between first edge 24 and second edge 26. In the embodiment of FIGS. 1 and 2, first edge 24 and second edge 26 are generally parallel with a vertical axis of plastic container 10. Indicia 28 may be printed directly on first face 18. Repositionable pressure sensitive adhesive coating 22 (shown in FIG. 4) is applied to second face 20 of polyester substrate 16 of label 14 and covers substantially all of second face 20 (shown in FIG. 4) of polyester substrate 16. In the embodiment of FIGS. 1 and 2, repositionable pressure sensitive adhesive coating 22 entirely covers second face 20 of polyester substrate 16. Once label 14 has been attached to plastic container 10, repositionable pressure sensitive adhesive coating 22 is disposed between second face 20 of polyester substrate 16 and exterior surface 12 of plastic container 10. Repositionable pressure sensitive adhesive coating 22 alone connects label 14 to plastic container 10.

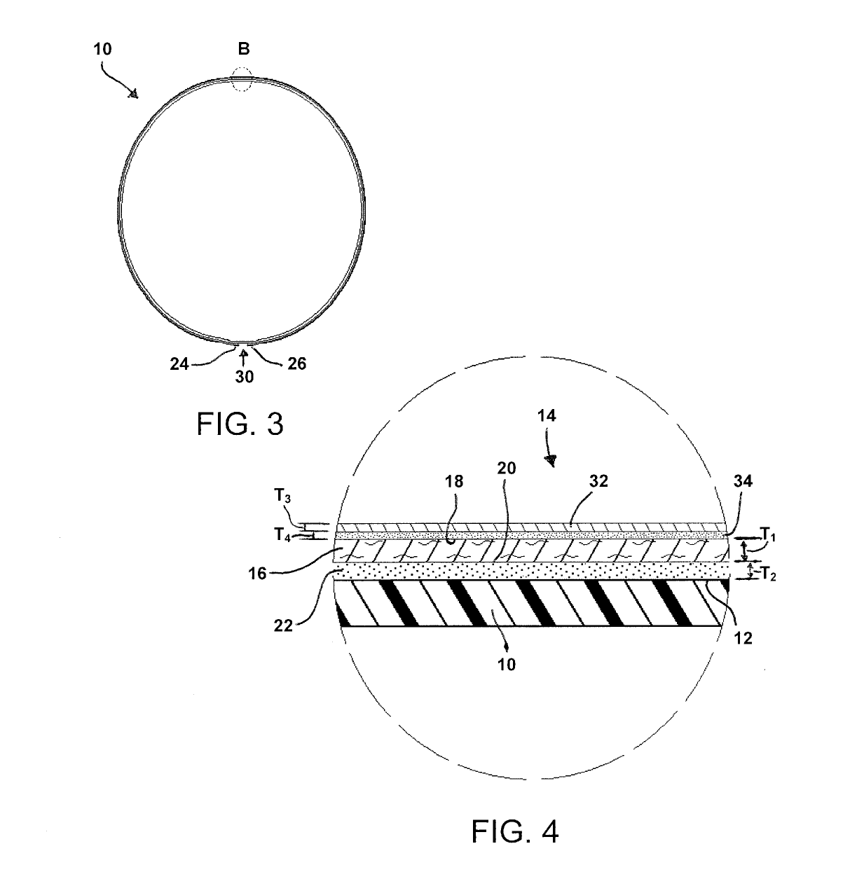

FIG. 3 is a cross sectional top view of the embodiment of plastic container 10 from FIGS. 1 and 2 taken along line A-A. Plastic container 10 includes exterior surface 12, circumference C₁ of exterior surface 12, label 14, and gap 30. Label 14 includes polyester substrate 16, first face 18, second face 20 (shown in FIG. 4), repositionable pressure sensitive adhesive coating 22 (shown in FIG. 4), first edge 24, second edge 26, and length L₁ between first edge 24 and second edge 26. Once label 14 has been attached to plastic container 10, length L₁ of label 14 extends from first edge 24 to second edge 26 along circumference C₁ of exterior surface 12 of plastic container 10. In the embodiment of FIG. 3, length L₁ may be shorter than circumference C₁ such that a portion of exterior surface 12 remains uncovered by label 14 and gap 30 exists between first edge 24 and second edge 26. Gap 30 may assist a recycler in subsequent removal of label 14 from plastic container 10 by providing sufficient clearance for a tool, such as a blade or finger nail, to catch first edge 24 or second edge 26 during the pealing process. In some embodiments, length L₁ may be equal to circumference C₁ such that no gap exists between first edge 24 and second edge 26.

FIG. 4 is an expanded cross sectional view of the embodiment from FIG. 3 taken inside circle B. Plastic container 10 includes exterior surface 12 and label 14. Label 14 includes polyester substrate 16, first face 18, second face 20, and repositionable pressure sensitive adhesive coating 22. Label 14 may also include laminate film 32 and permanent adhesive coating 34. Polyester substrate includes thickness T₁ and repositionable pressure sensitive adhesive coating 22 includes thickness T₂. Laminate film 32 includes thickness T₃ and permanent adhesive coating 34 includes thickness T₄.

As discussed above repositionable pressure sensitive adhesive coating 22 is disposed on second face 20 of polyester substrate 16 of label 14 and bonds second face 20 to exterior surface 12 of plastic container 10. Thickness T₁ of polyester substrate 16 is the distance between first face 18 and second face 20 of polyester substrate 16 and is approximately 1.2 mils to 1.6 mils. In the embodiment of FIG. 4, thickness T₁ of polyester substrate 16 is approximately 1.4 mils. Thickness T₂ of repositionable pressure sensitive adhesive coating 22 is the distance repositionable pressure sensitive adhesive coating 22 spans between second face 20 of polyester substrate 16 and exterior surface 12 of plastic container 10 while label 14 is connected to plastic container 10. Thickness T₂ of repositionable pressure sensitive adhesive coating 22 is approximately 0.6 mils to 1.1 mils. In the embodiment of FIG. 4, thickness T₂ of repositionable pressure sensitive adhesive coating is approximately 0.8 mils. Repositionable pressure sensitive adhesive coating 22 may be an acrylic based adhesive. Permanent adhesive coating 34 is sandwiched between laminate film 32 and first face 18 of polyester substrate 16 and adheres laminate film 32 to first face 18 such that laminate film 32 covers first face 18 and protects any indicia printed on first face 18. Laminate film 32 may be made from polypropylene and thickness T₃ of laminate film 32 may be approximately 0.5 mil to 1.0 mil. Permanent adhesive coating 34 may be any adhesive that permanently adheres laminate film 32 to first face 18 of polyester substrate 16. In the embodiment of FIG. 4 permanent adhesive coating 34 is an emulsion acrylic and thickness T₄ of permanent adhesive coating 34 is approximately 0.25 mil.

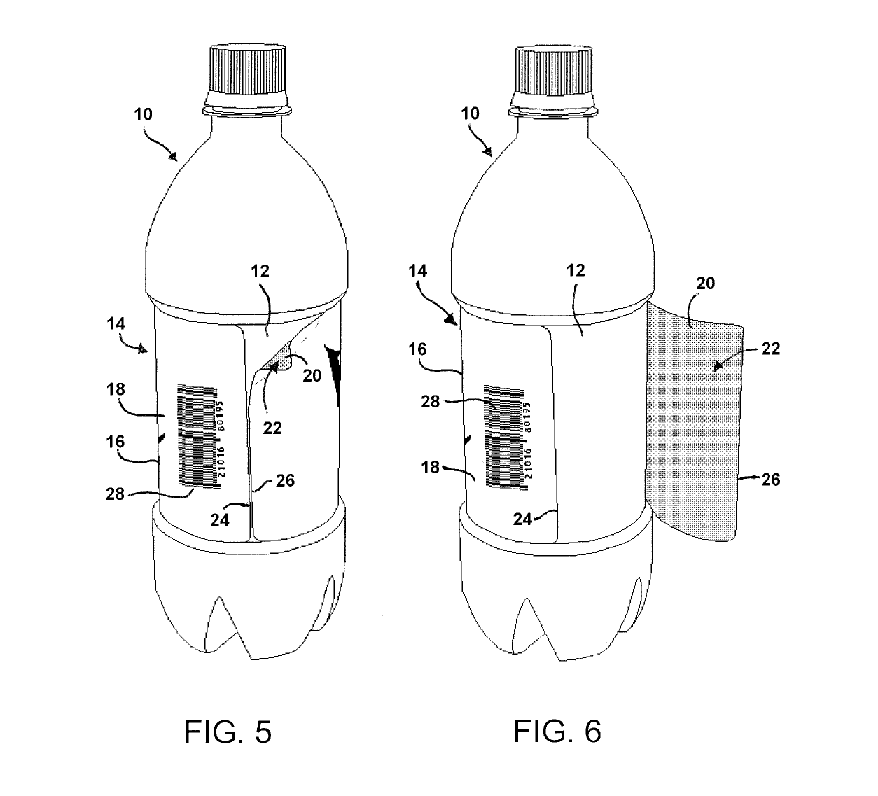

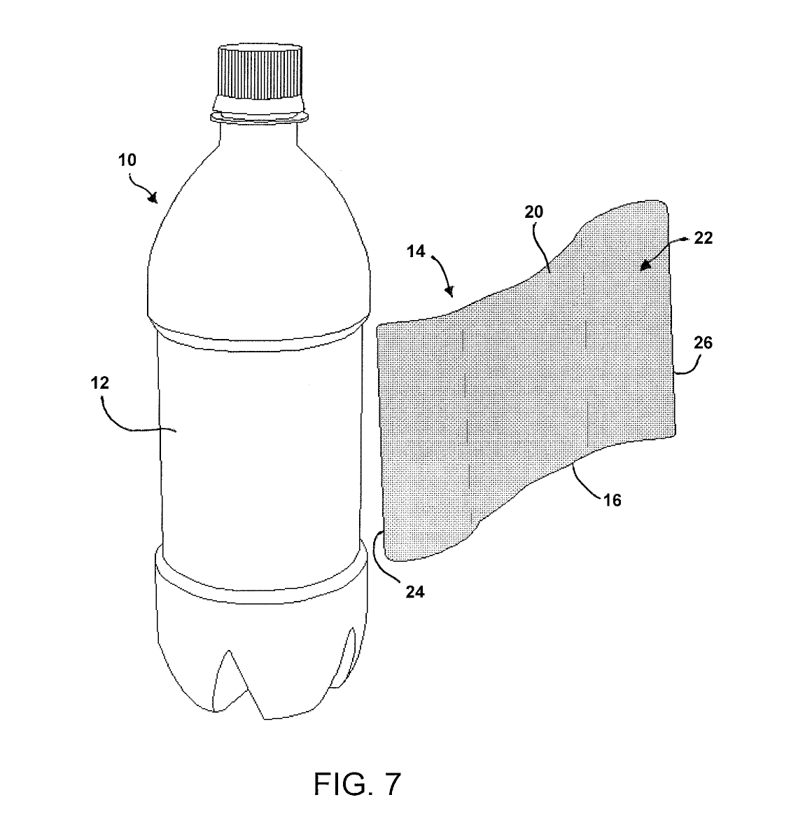

FIGS. 5, 6, and 7 show a perspective view of label 14 and plastic container 10 of the embodiment in FIGS. 1-4. Label 14 includes polyester substrate 16, first face 18, second face 20, repositionable pressure sensitive adhesive coating 22, first edge 24, and second edge 26. Label 14 may also include indicia 28. Repositionable pressure sensitive adhesive coating 22 is disposed on second face 20 and alone adheres polyester substrate 16 to and along exterior surface 12 of plastic container 10 with a peel strength of approximately 20 Oz/in to 40 Oz/in. Repositionable pressure sensitive adhesive coating 22 may cover second face 20 of polyester substrate 16 in a substantially even and unbroken solid coating. Because repositionable pressure sensitive adhesive coating 22 adheres polyester substrate 16 of label 14 to plastic container 10 with a peel strength of approximately 20 Oz/in to 40 Oz/in, label 14 is sufficiently secured to exterior surface 12 of plastic container 10 thereby preventing label 14 from unintentionally shifting on or detaching from plastic container 10 as plastic container 10 is handled by both commercial merchants and consumers prior to recycling. Once plastic container is ready to be recycled, the consumer or commercial recycler can remove label 14 from plastic container 10 by lifting first edge 24 or second edge 26 of polyester substrate 16 away from exterior surface 12 of plastic container 10 and by peeling or pulling polyester substrate 16 away from exterior surface 12 until polyester substrate 16 no longer contacts exterior surface 12 of plastic container 10. Because polyester substrate 16 is made of polyester film with thickness T1 of approximately 1.2 mils to 1.6 mils, and because repositionable pressure sensitive adhesive coating 22 may be an acrylic base adhesive with thickness T₂ of approximately 0.6 mils to 1.1 mils, polyester substrate 16 and repositionable pressure sensitive adhesive 22 peel away from exterior surface 12 of plastic container 10 without polyester substrate 16 tearing or ripping and without leaving any remnants or traces of repositionable pressure sensitive adhesive coating 22 on exterior surface 12 of plastic container 10. Label 14 is completely removed from plastic container 10 in a single action without leaving any traces of ink or adhesive from label 14 that might contaminate the recycling process of plastic container 10.

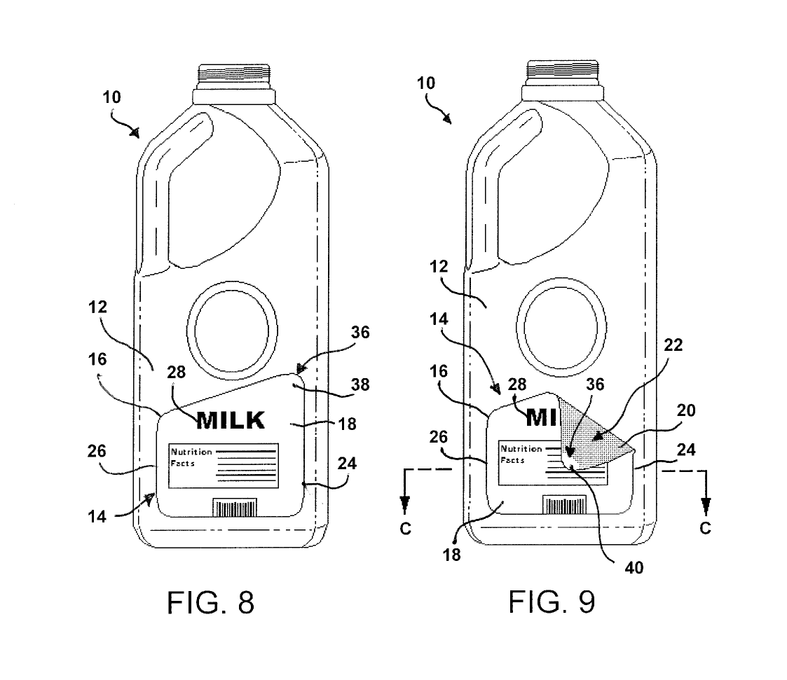

FIGS. 8 and 9 disclose a front view of another embodiment of plastic container 10 with label 14. As previously discussed, plastic container 10 may be any plastic article capable of being recycled. In FIGS. 8 and 9 plastic container 10 is a milk carton. Plastic container 10 includes exterior surface 12, and label 14. Label 14 includes polyester substrate 16, first face 18, second face 20, repositionable pressure sensitive adhesive coating 22, first edge 24, second edge 26, and length L₁ between first edge 24 and second edge 26. Label 14 may also include indicia 28 and tab 36. Tab 36 includes first face 38 and second face 40.

First face 18 of polyester substrate 16 is disposed opposite second face 20 of polyester substrate 16. First edge 24 of polyester substrate 16 is disposed opposite second edge 26, and length L₁ of polyester substrate 16 extends between first edge 24 and second edge 26. First edge 24 and second edge 26 are generally parallel with a vertical axis of plastic container 10. Repositionable pressure sensitive adhesive coating 22 is applied to second face 20 of polyester substrate 16 of label 14 and covers substantially all of second face 20 of polyester substrate 16. Once label 14 has been attached to plastic container 10, repositionable pressure sensitive adhesive coating 22 is disposed between second face 20 of polyester substrate 16 and exterior surface 12 of plastic container 10. Repositionable pressure sensitive adhesive coating 22 alone connects label 14 to plastic container 10. Tab 36 is integral with polyester substrate 16 and may be disposed a long any edge portion of polyester substrate 16. In the embodiment of FIGS. 8 and 9, tab 36 forms a corner of polyester substrate 16. First face 38 of tab 36 is continuous with first face 18 of polyester substrate 16 and second face 40 of tab 36 is continuous with second face 20 of polyester substrate 16. While second face 20 of polyester substrate is substantially coated by repositionable pressure sensitive adhesive coating 22, repositionable pressure sensitive adhesive coating 22 does not cover second face 40 of tab 36. Tab 36 facilitates the removal of label 14 from plastic container 10 by making it easier for consumers or commercial recyclers to grasp first edge 24 or second edge 26, or any other edge that may be present on polyester substrate 16 of label 14.

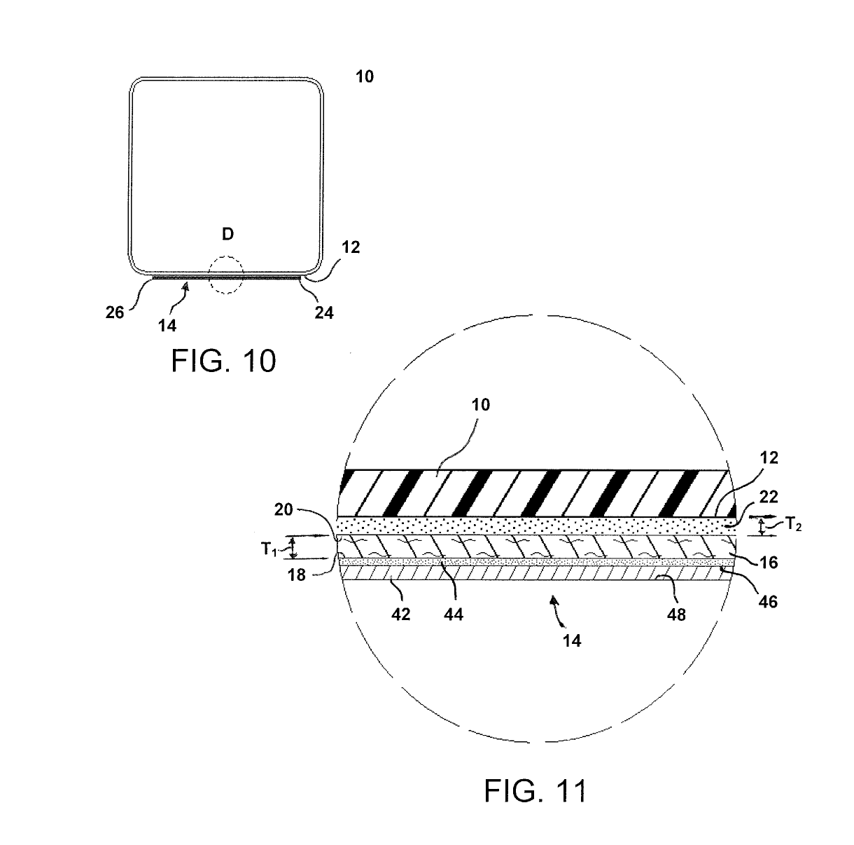

FIG. 10 is a cross sectional top view of the embodiment of plastic container 10 from FIGS. 8 and 9 taken along line C-C. Plastic container 10 includes exterior surface 12, circumference C₁ of exterior surface 12, and label 14. Label 14 includes polyester substrate 16, first face 18, second face 20 (shown in FIG. 11), repositionable pressure sensitive adhesive coating 22 (shown in FIG. 11), first edge 24, second edge 26, and length L₁ between first edge 24 and second edge 26. Once label 14 has been attached to plastic container 10, length L₁ of label 14 extends from first edge 24 to second edge 26 along circumference C₁ of exterior surface 12 of plastic container 10. In the embodiment of FIG. 10, length L₁ is substantially shorter than circumference C₁ such that a majority of exterior surface 12 remains uncovered by label 14.

FIG. 11 is an expanded cross sectional view of the embodiment from FIG. 10 taken inside circle D. Plastic container 10 includes exterior surface 12 and label 14. Label 14 includes polyester substrate 16, first face 18, second face 20, and repositionable pressure sensitive adhesive coating 22. Label 14 may also include paper sheet 42 and permanent adhesive coating 44. Polyester substrate includes thickness T₁ and repositionable pressure sensitive adhesive coating 22 includes thickness T₂. Paper sheet 42 includes first face 46 and second face 48.

As discussed above repositionable pressure sensitive adhesive coating 22 is disposed on second face 20 of polyester substrate 16 of label 14 and bonds second face 20 to exterior surface 12 of plastic container 10. Thickness T₁ of polyester substrate 16 is the distance between first face 18 and second face 20 of polyester substrate 16 and is approximately 1.2 mils to 1.6 mils. In the embodiment of FIG. 11, thickness T₁ of polyester substrate 16 is approximately 1.4 mils. Thickness T₂ of repositionable pressure sensitive adhesive coating 22 is the distance repositionable pressure sensitive adhesive coating 22 spans between second face 20 of polyester substrate 16 and exterior surface 12 of plastic container 10 while label 14 is connected to plastic container 10. Thickness T₂ of repositionable pressure sensitive adhesive coating 22 is approximately 0.6 mils to 1.1 mils. In the embodiment of FIG. 11, thickness T₂ of repositionable pressure sensitive adhesive coating is approximately 0.8 mils. Repositionable pressure sensitive adhesive coating 22 may be an acrylic based adhesive. Repositionable pressure sensitive adhesive coating 22 alone adheres polyester substrate 16 to exterior surface 12 of plastic container 10 with a peel strength of approximately 20 Oz/in to 40 Oz/in. Because repositionable pressure sensitive adhesive coating 22 adheres polyester substrate 16 of label 14 to plastic container 10 with a peel strength of approximately 20 Oz/in to 40 Oz/in, label 14 is sufficiently secured to exterior surface 12 of plastic container 10 prevent label 14 from unintentionally shifting on or detaching from plastic container 10 as plastic container 10 is handled by both commercial merchants and consumers prior to recycling. Once plastic container is ready to be recycled, the consumer or commercial recycler can remove label 14 from plastic container 10 by lifting first edge 24 or second edge 26 of polyester substrate 16 away from exterior surface 12 of plastic container 10 and by peeling or pulling polyester substrate 16 away from exterior surface 12 until polyester substrate 16 no longer contacts exterior surface 12 of plastic container 10. Because polyester substrate 16 is made of polyester film with thickness T1 of approximately 1.2 mils to 1.6 mils, and because repositionable pressure sensitive adhesive coating 22 may be an acrylic base adhesive with thickness T₂ of approximately 0.6 mils to 1.1 mils, polyester substrate 16 and repositionable pressure sensitive adhesive 22 peel away from exterior surface 12 of plastic container 10 without polyester substrate 16 tearing or ripping and without leaving any remnants or traces of repositionable pressure sensitive adhesive coating 22 on exterior surface 12 of plastic container 10. Label 14 is completely removed from plastic container 10 in a single action without leaving any traces of ink or adhesive from label 14 that might contaminate the recycling process of plastic container 10.

The surface area of first face 44 and second face 48 of paper sheet 42 may be sized to match the surface area first face 18 and second face 20 of polyester substrate 16. Permanent adhesive coating 44 is sandwiched between second face 48 of paper sheet 42 and first face 18 of polyester substrate 16 and adheres second face 48 of paper sheet 42 to first face 18 such that paper sheet 42 covers first face 18 of polyester substrate 16. Permanent adhesive coating 44 may be any adhesive that permanently adheres paper sheet 42 to first face 18 of polyester substrate 16. Indicia may be printed directly onto first face 46 of paper sheet 42.

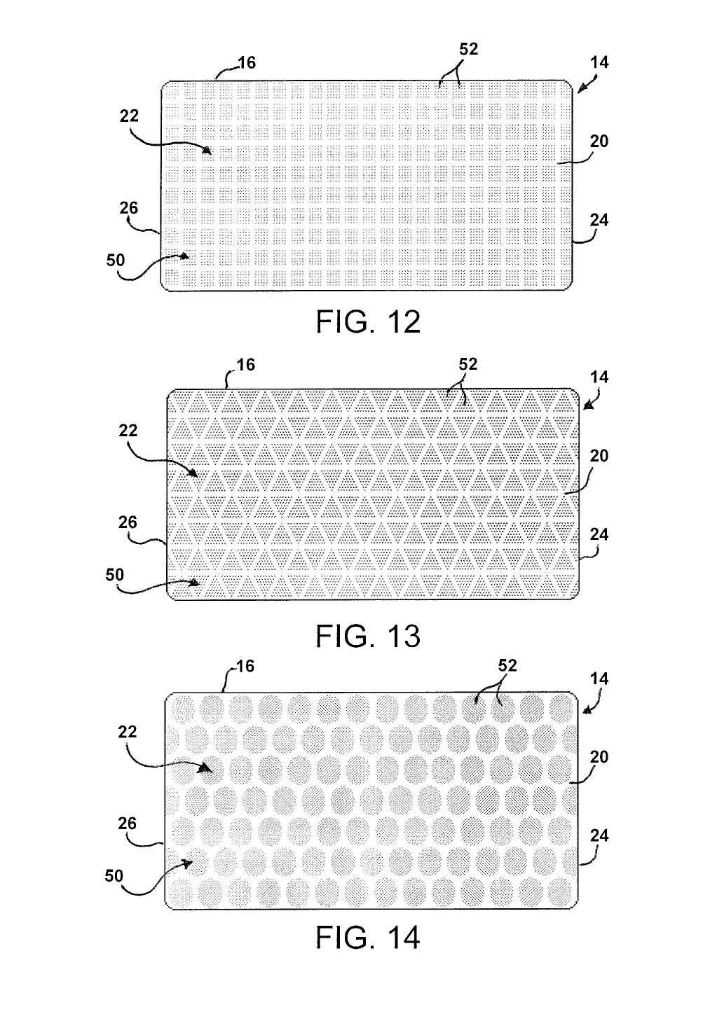

FIG. 12 is a back view of another embodiment of label 14. Label 14 includes polyester substrate 16, first face 18 (shown in FIG. 4), second face 20, repositionable pressure sensitive adhesive coating 22, first edge 24, and second edge 26. Repositionable pressure sensitive adhesive coating 22 may include pattern 50. Pattern 50 may include polygonal shaped adhesive sections 52 of repositionable pressure sensitive adhesive coating.

Repositionable pressure sensitive adhesive coating 22 is disposed on second face 20 of polyester substrate 16 of label 14 and bonds second face 20 to exterior surface 12 (shown in FIG. 4) of plastic container 10 (shown in FIG. 4) once applied to exterior surface 12 of plastic container 10. Repositionable pressure sensitive adhesive coating 22 may be an acrylic based adhesive. Repositionable pressure sensitive adhesive coating 22 alone adheres polyester substrate 16 to and along exterior surface 12 of plastic container 10 with a peel strength of approximately 20 Oz/in to 40 Oz/in. Repositionable pressure sensitive adhesive coating 22 may be segmented into pattern 50 of polygonal shaped adhesive sections 52 spaced apart from each other on second face 20 of polyester substrate 16. Segmenting repositionable pressure sensitive adhesive coating 22 into pattern 50 of polygonal shaped adhesive sections 52 effectively adjusts the peel strength of label 14 between 20 Oz/in to 40 Oz/in by adjusting the amount of repositionable pressure sensitive adhesive coating 22 present on second face 20 of polyester substrate 16 of label 14. Because repositionable pressure sensitive adhesive coating 22 adheres polyester substrate 16 of label 14 to plastic container 10 with peel strength of approximately 20 Oz/in to 40 Oz/in, label 14 is sufficiently secured to exterior surface 12 of plastic container 10 preventing label 14 from unintentionally shifting on or detaching from plastic container 10 as plastic container 10 is handled by both commercial merchants and consumers prior to recycling. Polygonal shaped adhesive sections 52 may be square in shape.

FIG. 13 is a back view of another embodiment of label 14. Label 14 includes polyester substrate 16, first face 18 (shown in FIG. 4), second face 20, repositionable pressure sensitive adhesive coating 22, first edge 24, and second edge 26. Repositionable pressure sensitive adhesive coating 22 may include pattern 50. Pattern 50 may include polygonal shaped adhesive sections 52 of repositionable pressure sensitive adhesive coating.

Repositionable pressure sensitive adhesive coating 22 is disposed on second face 20 of polyester substrate 16 of label 14 and bonds second face 20 to exterior surface 12 (shown in FIG. 4) of plastic container 10 (shown in FIG. 4) once applied to exterior surface 12 of plastic container 10. Repositionable pressure sensitive adhesive coating 22 may be an acrylic based adhesive. Repositionable pressure sensitive adhesive coating 22 alone adheres polyester substrate 16 to and along exterior surface 12 of plastic container 10 with a peel strength of approximately 20 Oz/in to 40 Oz/in. Repositionable pressure sensitive adhesive coating 22 may be segmented into pattern 50 of polygonal shaped adhesive sections 52 spaced apart from each other on second face 20 of polyester substrate 16. Segmenting repositionable pressure sensitive adhesive coating 22 into pattern 50 of polygonal shaped adhesive sections 52 effectively adjusts the peel strength of label 14 between 20 Oz/in to 40 Oz/in by adjusting the amount of repositionable pressure sensitive adhesive coating 22 present on second face 20 of polyester substrate 16 of label 14. Because repositionable pressure sensitive adhesive coating 22 adheres polyester substrate 16 of label 14 to plastic container 10 with peel strength of approximately 20 Oz/in to 40 Oz/in, label 14 is sufficiently secured to exterior surface 12 of plastic container 10 preventing label 14 from unintentionally shifting on or detaching from plastic container 10 as plastic container 10 is handled by both commercial merchants and consumers prior to recycling. Polygonal shaped adhesive sections 52 may be triangular in shape.

FIG. 14 is a back view of another embodiment of label 14. Label 14 includes polyester substrate 16, first face 18 (shown in FIG. 4), second face 20, repositionable pressure sensitive adhesive coating 22, first edge 24, and second edge 26. Repositionable pressure sensitive adhesive coating 22 may include pattern 50. Pattern 50 may include circular adhesive sections 54 of repositionable pressure sensitive adhesive coating.

Repositionable pressure sensitive adhesive coating 22 is disposed on second face 20 of polyester substrate 16 of label 14 and bonds second face 20 to exterior surface 12 (shown in FIG. 4) of plastic container 10 (shown in FIG. 4) once applied to exterior surface 12 of plastic container 10. Repositionable pressure sensitive adhesive coating 22 may be an acrylic based adhesive. Repositionable pressure sensitive adhesive coating 22 alone adheres polyester substrate 16 to and along exterior surface 12 of plastic container 10 with a peel strength of approximately 20 Oz/in to 40 Oz/in. Repositionable pressure sensitive adhesive coating 22 may be segmented into pattern 50 of circular adhesive sections 54 spaced apart from each other on second face 20 of polyester substrate 16. Segmenting repositionable pressure sensitive adhesive coating 22 into pattern 50 of circular adhesive sections 54 effectively adjusts the peel strength of label 14 between 20 Oz/in to 40 Oz/in by adjusting the amount of repositionable pressure sensitive adhesive coating 22 present on second face 20 of polyester substrate 16 of label 14. Because repositionable pressure sensitive adhesive coating 22 adheres polyester substrate 16 of label 14 to plastic container 10 with peel strength of approximately 20 Oz/in to 40 Oz/in, label 14 is sufficiently secured to exterior surface 12 of plastic container 10 preventing label 14 from unintentionally shifting on or detaching from plastic container 10 as plastic container 10 is handled by both commercial merchants and consumers prior to recycling.

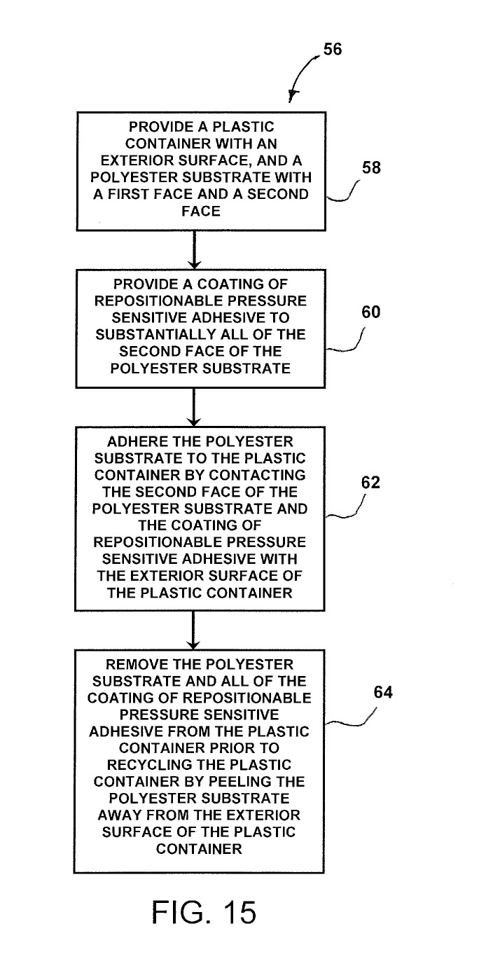

FIG. 15 discloses a diagram of combined labeling and recycling method 56 that includes the steps of providing a plastic container with an exterior surface and a polyester substrate with a first face and a second face 58. A coating of repositionable pressure sensitive adhesive is provided to substantially all of the second face of the polyester substrate 60. The polyester substrate is adhered to the plastic container by contacting the second face of the polyester substrate and the coating of repositionable pressure sensitive adhesive with the exterior surface of the plastic container 62. The polyester substrate and all of the coating of repositionable pressure sensitive adhesive is removed from the plastic container prior to recycling the plastic container by peeling the polyester substrate away from the exterior surface of the plastic container 64.

In view of the foregoing description, it will be recognized that the present disclosure provides numerous advantages and benefits. For example, the present disclosure provides a plastic container 10 with label 14 that is adhered to plastic container 10 and can be removed from plastic container 10 in a single action without leaving any ink or adhesive residue on plastic container 10 that might contaminate the recycling of plastic container 10. Furthermore, though label 14 is non-permanently adhered to plastic container 10, label 14 is adhered to plastic container 10 with sufficient peel strength to prevent label 14 from unintentionally shifting on or detaching from plastic container 10 as plastic container 10 is handled by both commercial merchants and consumers prior to recycling.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A plastic container, comprising:
a plastic body with an exterior surface;
a polyester substrate with a first face, a second face and a thickness of about 1.2 mils to about 1.6 mils between the first face and the second face;
a coating of repositionable pressure sensitive adhesive disposed on and substantially covering all of the second face of the polyester substrate, the coating of repositionable pressure sensitive adhesive nonpermanently adhering the second face of the polyester substrate to the exterior surface of the plastic container.

2. The plastic container of claim 1, wherein the polyester substrate comprises a first edge opposite a second edge and a length in between the first edge and the second edge of the polyester substrate.

3. The plastic container of claim 2, wherein the length of the polyester substrate is less than or equal to a circumference of the exterior surface of the plastic container.

4. The plastic container of claim 1, wherein the coating of repositionable pressure sensitive adhesive covers the entire second face of the polyester substrate.

5. The plastic container of claim 1, wherein the polyester substrate comprises a tab with a first face continuous with the first face of the polyester substrate and a second face continuous with the second face of the polyester substrate.

6. The plastic container of claim 5, wherein the coating of repositionable pressure sensitive adhesive covers the second face of the polyester substrate without covering the second face of the tab.

7. The plastic container of claim 5, wherein the tab is formed from a corner of the polyester substrate.

8. The plastic container of claim 1, wherein the coating of repositionable pressure sensitive adhesive has a thickness of about 0.6 mils to about 1.1 mils.

9. The plastic container of claim 1, wherein the coating of repositionable pressure sensitive adhesive is acrylic.

10. The plastic container of claim 1, wherein the polyester substrate has a thickness of about 1.2 mils to about 1.6 mils.

11. The plastic container of claim 1, wherein the polyester substrate and the coating of repositionable pressure sensitive adhesive peel away from the plastic container with a peel strength in the range of about 20 Oz/in to about 40 Oz/in.

12. The plastic container of claim 1, wherein indicia is printed directly onto the first face of the polyester substrate and a polypropylene film is adhered to the first face of the polyester substrate.

13. The plastic container of claim 12, wherein the polypropylene film has a thickness of 0.5 mil to 1.0 mil.

14. The plastic container of claim 1, wherein a permanent adhesive adheres a second face of a paper sheet to the first face of the polyester substrate and indicia is printed on a first face of the paper sheet.

15. The plastic container of claim 14, wherein the first and second faces of the paper sheet comprise a surface area equal to or less than a surface area of the first and second faces of the polyester substrate.

16. The plastic container of claim 1, wherein the coating of repositionable pressure sensitive adhesive forms a pattern of polygonal shaped adhesive sections spaced apart from each other on the second face of the polyester substrate.

17. The plastic container of claim 16, wherein the polygonal shaped adhesive sections are triangular.

18. The plastic container of claim 1, wherein the coating of repositionable pressure sensitive adhesive forms a pattern of circular adhesive sections spaced apart from each other on the second face of the polyester substrate.

19. A method of labeling a recyclable container, comprising the steps of:
providing an exterior surface on the recyclable container;
providing a polyester substrate with a first face and a second face and a thickness there between of about 1.2 mils to about 1.6 mils;
providing a coating of repositionable pressure sensitive adhesive to substantially all of the second face of the polyester substrate, the repositionable pressure sensitive adhesive having a thickness of about 0.6 mils to about 1.1 mils; and
adhering the polyester substrate to the recyclable container by contacting the second face of the polyester substrate and the coating of repositionable pressure sensitive adhesive with the exterior surface of the recyclable container.

20. A method comprising:
providing a plastic container with an exterior surface;
providing a polyester substrate with a first face and a second face;
providing a coating of repositionable pressure sensitive adhesive to substantially all of the second face of the polyester substrate;
adhering the polyester substrate to the plastic container by contacting the second face of the polyester substrate and the coating of repositionable pressure sensitive adhesive with the exterior surface of the plastic container, such adhering providing that polyester substrate and all of the coating of repositionable pressure sensitive adhesive may be subsequently removed from the plastic container prior to recycling the plastic container solely by peeling the polyester substrate away from the exterior surface of the plastic container.
